(19) United States
(12) Patent Application Publication
(10) Pub. No.: US 2002/0189839 A1
(43) Pub. Date: Dec. 19, 2002

(54) Cable

(75) Inventors: Philippa C. Wagner, London (GB); David A. Eves, Crawley (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/155,319

(22) Filed: May 24, 2002

(30) Foreign Application Priority Data
Jun. 19, 2001 (GB) 0114979.8

(51) Int. Cl. H01B 1/00; H02G 1/00

(52) U.S. Cl. 174/68.1

(57) ABSTRACT

Textile spinning techniques are employed to produce electrical cables in the form of a yarn having a structure comprised of a number of elements arranged in the axial direction of the cable. Two or more such elements may be arranged co-axially with respect to each other. In one particular example, the cable has an internal conducting core surrounded by an insulating layer and a conducting layer surrounding the insulating layer. An outer-most presentation layer may also be provided. The presentation layer is chosen to give the cable the required look and feel. In principle, a large selection of conducting and insulating fibers (of either metallic or non-metallic material) may be used in the spinning process allowing a very large variety of different cable constructions to be produced.

The present invention relates to cables, and more particularly, but not exclusively, to cables suitable for incorporation into apparel, clothing accessories, soft furnishings, upholstered items and other such articles.

A wide variety of electrical cables are available on the market and they range from straightforward constructions having a single conductor through to more complex constructions having, for example, multiple conductors, a coaxial conductor arrangement or shielded subsets of conductors. Some cables are intended for use in quite specific applications and when designing such cables a number of factors need to be taken into consideration. These include the characteristics of the electrical current or signal that the cable needs to convey and the intended environmental conditions that the cable will need to operate within. Other factors relate to the more mechanical aspects of the cable such as how flexible it needs to be, whether it should be compatible with particular post-manufacture processes and even it's visual appearance and feel.

Traditionally, the electronics industry and the clothing industry have produced products in different fields and have remained apart. More recently, a joint project between Philips Electronics and Levi Strauss® culminated in the launch of the Levi's ICD+ jacket range in 2000. The jackets of this range were designed to carry a mobile telecommunications device, portable audio device (an MP3 player), user headphones and a microphone. The jackets were also provided with wiring to connect these devices together and a user keypad for controlling the devices and providing added functionality in terms of synchronising device operation.

The Levi's ICD+ jackets are an example of non-rigid items which require a component part, in this case an electrical cable, more generally associated with the electrical or electronics industry than with the clothing industry. However, while such cable or cabling must be able, to perform the function of conveying electrical current or signals, it's use in a garment requires the cable to have other characteristics. Such a cable should be flexible enough to bend with the garment during use and be sufficiently discrete such that even when the cable is located beneath the exterior surface of the garment, the presence of the cable does not detract from the appearance or hang of the garment. Furthermore, the presence of the cable should not cause discomfort to the person using the garment. Some of these characteristics are also desirable when cabling is fitted to other items such as clothing accessories, soft furnishings or other fabric based ‘soft’ items.

Some known attempts to provide electrical current or signal carrying conductors in fabric based articles have been based on standard ‘flat’ textile structures of woven or knitted layers. The conductors are provided by including conductive yarns during the knitting or weaving process or by applying conductive layers to the yarn at a later stage. These approaches lead to arrangements occupying relatively large surface areas, especially when there is a need to separate multiple conductors, and difficulties with reliably insulating and isolating selected parts of the circuitry that the conductors form. It can also be difficult to provide shielding for these arrangements, as is often required to minimise electromagnetic emission or the effects of external interference. Furthermore, flexing or stretching of such conductive yarns can modify their electrical characteristics which can result in electrical noise.

Yarns can be made from synthetic fibres that are rendered conductive by electrolessly plating them with metals. However, such fibres tend to look metallic, cannot be easily dyed or colour matched and may not always have the feel suitable for use in fabric based ‘soft’ items.

It is an object of the present invention to provide an electrical cable which may be suitable for including in items such as garments, clothing accessories, soft furnishings, upholstered articles and other such ‘soft’ items.

In accordance with the present invention there is provided an electrical cable including a spun structure, said spun structure comprising at least one electrically conductive element. The said spun structure may further comprising at least one electrically insulative element.

In one arrangement, said cable spun structure may comprise one or more first said electrically conductive element arranged to form a core; and

one or more first said electrically insulative element arranged to form an insulating layer substantially surrounding an associated said core.

These and other aspects of the present invention appear in the appended claims which are incorporated herein by reference and to which the reader is now referred.

The present invention will now be described by way of example with reference to the Figures of the accompanying drawings in which:

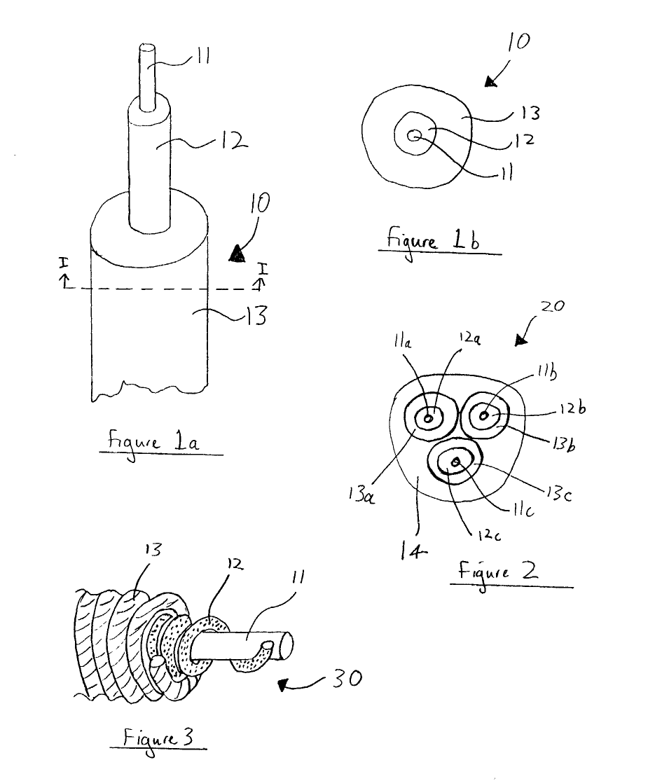

FIG. 1a shows a perspective view of a first embodiment of a cable made in accordance with the present invention;

FIG. 1b shows a cross sectional view of the first embodiment cable taken along the line I-I of FIG. 1a;

FIG. 2 shows a cross sectional view of a second embodiment of a cable made in accordance with the present invention; and

FIG. 3 shows a perspective view of a third embodiment of a cable made in accordance with the present invention.

It should be noted that the drawings are diagrammatic and not drawn to scale. Relative dimensions and proportions of parts of the Figures have been shown exaggerated or reduced in size for the sake of clarity and convenience in the drawings. The same reference signs are generally used to refer to corresponding or similar features in the different embodiments.

With reference to FIGS. 1a and 1b, a first embodiment of the invention in the form of an electrical cable 10 comprises a first conductive element in the form of central core 11 substantially surrounded by a first electrically insulative element arranged to form an insulating layer 12 which substantially surrounds the core 11. The cable may further comprise a second electrically conductive element arranged to form a conducting layer 13 which substantially surrounds the insulating layer 12. The cable may have further conducting and insulating layers as will be apparent to the person skilled in the art. The spun elements make up a spun structure. The further conducting and insulating layers may also be provided in spun form to make up part of the spun structure or be provided in other ways, for example in the form of a braiding or tape, as will be apparent to the person skilled in the art. Such electrical cables may be produced to convey power or data. In the case of conveying power, cables may be tailored to perform at the necessary voltage or current rating. In the case of conveying data, cables may be tailored so they perform at the required frequency or other electrical parameters. Particular electromagnetic shielding requirements may also affect the design of the cable, as can required mechanical characteristics and environmental conditions within which the cable must perform.

FIG. 2 shows a second embodiment of the invention in the form of an electrical cable 20 which consists of three first conductive elements each forming a core 11a, 11b, 11c, each being substantially surrounded by an associated first electrically insulative element arranged to form a respective insulating layer 12a, 12b, 12c. Each first electrically insulative element 12a, 12b, 12c is substantially surrounded by an associated second conductive element arranged to form a conductive layer 13a, 13b, 13c around the respective insulative element 12a, 12b, 12c. Each conductive layer 13a, 13b, 13c is collectively surrounded by a common second electrically insulative element arranged to form insulating layer 14. In an alternative arrangement each core 11a, 11b, 11c and associated insulating layer 12a, 12b, 12c pair could be collectively surrounded by a common second conductive element arranged to form common conductive layer 13. This may in turn be surrounded by a common second electrically insulative element arranged to form common insulating layer 14. The cable may have further conducting and insulating layers as will be apparent to the person skilled in the art. The spun elements make up a spun structure. The further insulating and conducting layers may also be provided in spun form to make up part of the spun structure or be provided in other ways, for example in the form of a braiding or tape, as will be apparent to the person skilled in the art.

Thus, textile spinning techniques are employed to produce electrical cables of the present invention in the form of a yarn having a structure comprised of a number of elements arranged in the axial direction of the cable. Two or more such elements may be arranged co-axially with respect to each other. In one particular example, the cable has an internal conducting core surrounded by an insulating layer, a conducting layer surrounding the insulating layer.

It is possible to provide the cable with an externally visible presentation layer. This layer may be the outer-most layer. An outer-most layer of the cable (which may also be the presentation layer) is chosen to give the cable the required look and feel. In principle, a large selection of conducting and insulating fibres (of either metallic or non-metallic material) may be used in the spinning process allowing a very large variety of different cable constructions to be produced.

A wide range of cables having various arrangements of electrical conductors and insulators is possible, in terms of number of conductors and insulators and how each conductor and insulator is arranged with respect to other conductors and insulators, as will be apparent to the person skilled in the art.

A range of spinning techniques can be used to produce cables, for example core-spinning to produce core-spun yarns, gimp spinning and double covering. A spun cable 30 of the present invention produced by double covering is illustrated in FIG. 3. In this example a first conductive core 11 is covered by spinning onto it a first inner covering 12 of an insulating material (shown with dot shading for clarity) and a second outer covering 13 of conductive material (shown with line shading for clarity), the outer covering 13 being supported by the inner covering 12.

In the above examples cables have consisted of conductive cores although insulating cores and conductive layers could be provided.

In one particular arrangement of a core-spun cable, the core is of copper which is surrounded by an insulating layer of tactel®. Surrounding the insulating layer is a silver coated material to form a shield/screen and the outermost layer is chosen to achieve the required look and feel. In another arrangement, the core is of electrolessly plated silver yarn surrounded by a polyamide insulator, which in turn is surrounded by a silver coated shield/screen, finally covered with an outermost layer chosen to achieve the required look and feel. The outermost layer or look layer may be dyed to take on an appearance in keeping with the item the cable is to form a part of. The outermost layer may be selected to give the cable the required ‘handle’ or feel.

Each conductive or insulative element may be monofilament or multifilament. Multifilament elements may be of the same material or a range of materials. In the case of electrically conductive elements, they may be of one or more conductive material or a mixture of conductive and insulative materials. Optical fibres for optical communication of data could be included in the cables.

Cable of the present invention may themselves be used as a yarn in producing articles that are of a woven, knitted or embroidered construction.

Various cable arrangements may be produced with different spinning techniques and varying numbers of yarns, as will be appreciated by the person skilled in the art. For example, different ‘counts’ of yarn may be created. While traditional cable spinning techniques may be employed, such as core spinning it is also possible to consider producing cables using other spinning techniques, such as by air-jet spinning and so forth. More than one spinning stage may be employed.

Cables made in accordance with the present invention have the potential to be made that are of a very low profile and potentially at low cost, even where a number of electrical conductors are to be included. A selection of suitable insulating materials include nylon, polyamide, acetate, cotton and wool. A selection as suitable conducting materials include carbon fibre conductive polymers or polymers otherwise having a conductive property due to their composition. Other suitable conducting materials include insulators such as polyamide coated with conductors, for example coatings of nickel, copper, aluminium, gold and silver.

The required cable performance characteristics can have an effect on the materials used. For example, certain applications will favour the use of polyamide rather than other particular insulative materials due to the dielectric constant of polyamide.

From reading the present disclosure, other modifications will be apparent to persons skilled in the art. Such modifications may involve other features which are already known in the design, manufacture and use of cables, garments, upholstered articles and other soft furnishings and applications thereof and which may be used instead of or in addition to features already described herein.

1. An electrical cable including a spun structure, said spun structure comprising at least one electrically conductive element.

2. An electrical cable according to claim 1, said spun structure comprising at least one electrically insulative element.

3. An electrical cable according to claim 2, said cable spun structure comprising one or more first said electrically conductive element arranged to form a core; and
one or more first said electrically insulative element arranged to form an insulating layer substantially surrounding an associated said core.

4. An electrical cable according to claim 3, said cable spun structure comprising one or more second said electrically conductive element each arranged to form a conducting layer substantially surrounding an associated one said insulating layer.

5. An electrical cable according to claim 4, said cable spun structure comprising one or more second said electrically conductive element each arranged to form a conducting layer substantially surrounding two or more said insulating layers collectively.

6. An electrical cable according to claim 2, said cable spun structure comprising one or more first said electrically insulative element arranged to form a core; and
one or more first said electrically conductive element arranged to form an conductive layer substantially surrounding an associated said core.

7. An electrical cable according to claim 3 and further comprising subsequent insulating layers and subsequent conducting layers.

8. A cable in accordance with claim 1, wherein said spun structure is core-spun or jet spun.

9. A cable in accordance with claim 1, wherein one or more electrically conductive element comprises a combination of electrically conductive and electrically insulative materials.

10. A cable in accordance with claim 1, wherein the or each electrically conductive element or electrically insulative element is provided in the form of one or more yarns.

11. A cable in accordance with claim 1, wherein an outermost layer of the electrical cable includes at least a proportion of material capable of accepting a coating so as to affect its perceived visible colour.

12. A method of producing a cable having the technical features of claim 1.

13. A method of producing a cable having the technical features of claim 3.

14. A method of producing an electrical cable comprising the step of:
spinning a structure comprising at least one electrically conductive element and at least one electrically insulative element, wherein the or each conductive and insulative element are arranged with respect to each other to form an electrical cable.

15. A method according to claim 13 wherein said at least one electrically insulative element is arranged to substantially surround said at least one electrically conductive element.
